(19) United States
(12) Patent Application Publication
(10) Pub. No.: US 2011/0172053 A1
(43) Pub. Date: Jul. 14, 2011

(54) Planet-gear speed reducer

(75) Inventor: Robin C.S. Chang, Taichung City (TW)

(73) Assignee: Apex Dynamics, Inc.

(21) Appl. No.: 12/657,057

(22) Filed: Jan. 13, 2010

(51) Int. Cl. F16H 57/08

(52) U.S. Cl. 475/331

(57) ABSTRACT

A planet-gear speed reducer includes a shell, a planet gear set, a sun gear set, two semi-bearings, and a bearing. The shell includes a toothed strip, a first smooth strip and a second smooth strip formed on an internal side. The planet gear set includes a carrier located within the shell and planet gears carried on the carrier. The sun gear set is engaged with the planet gears. The first semi-bearing includes an internal ring provided around a section of the carrier, rollers and a cage for positioning the rollers between the internal ring thereof and the first smooth strip of the shell. The second semi-bearing includes an internal ring provided around another section of the carrier, rollers and a cage for positioning the rollers between the internal ring thereof and the second smooth strip of the shell.

### BACKGROUND OF INVENTION

1. Field of Invention

The present invention relates to a planet-gear speed reducer and, more particularly, to a small and quiet planet-gear speed reducer.

2. Related Prior Art

A motor is often used to drive a device. However, the speed provided by the motor is too high and the torque provided by the motor is too small to drive the device properly. The high speed provided by the motor imposes a challenge on the strength of the device and could reduce the life of the device. Therefore, a speed reducer is provided between the motor and the device. A speed reducer can include various tiers each including a pinion engaged with a larger gear. Such a speed reducer however involves a complicated structure and makes intensive vibration and loud noise. To simply the structure and reduce the vibration and noise, a planet-gear speed reducer can be used. There have been various designs of planet-gear speed reducers.

A planet-gear speed reducer includes a cage, a planet gear set and a sun gear set. The cage includes teeth formed on an internal side. The planet gear set includes a carrier rotationally located in the cage and planet gears rotationally carried on the carrier. The teeth of the planet gears are engaged with the teeth of the cage. The sun gear set includes a sun gear engaged with the planet gears. An input end of the carrier is connected to the sun gear set that is in turn connected to the mandrel of the motor. An output end of the carrier is connected to the device.

Referring to FIG. 4, there is shown a conventional planet-gear speed reducer. Bearings are provided between the cage and the planet gear set to ensure smooth relative rotation between them. The bearings are fit in the cage. Therefore, there is stress in the cage. To withstand the stress, the thickness of the wall of the cage is thick, and an external diameter h2 of the cage is large. There are annular shoulders formed on the internal side of the cage. Each of the bearings is located against a related one of the annular shoulders to ensure precise positioning of the bearings in the cage. An axial dimension w2 of the cage is large. Furthermore, the making of the annular shoulders and the fitting of the bearings make it difficult to locate the planet gear set in the cage perfectly co-axially. The cage and the planet gear set would wear each other away if they were not perfectly co-axial.

The present invention is therefore intended to obviate or at least alleviate the problems encountered in prior art.

### SUMMARY OF INVENTION

It is the primary objective of the present invention to provide a small and reliable planet-gear speed reducer.

To achieve the foregoing objective, the planet-gear speed reducer includes a shell, a planet gear set, a sun gear set, two semi-bearings, and a bearing. The shell includes an annular toothed strip, a first annular smooth strip and a second annular smooth strip formed on an internal side. The planet gear set includes a carrier rotationally located within the shell and planet gears carried on the carrier. The sun gear set is engaged with the planet gears. The first semi-bearing includes an internal ring provided around a section of the carrier, rollers and a cage for positioning the rollers between the internal ring thereof and the first annular smooth strip of the shell. The second semi-bearing includes an internal ring provided around another section of the carrier, rollers and a cage for positioning the rollers between the internal ring thereof and the second annular smooth strip of the shell. The bearing is located between the sun gear set and the shell.

Other objectives, advantages and features of the present invention will become apparent from the following description referring to the attached drawings.

### BRIEF DESCRIPTION OF DRAWINGS

The present invention will be described via detailed illustration of the preferred embodiment versus the prior art referring to the attached drawings where:

FIG. 1 is a cut-away view of a planet-gear speed reducer according to the preferred embodiment of the present invention;

FIG. 2 is an exploded view of the planet-gear speed reducer shown in FIG. 1;

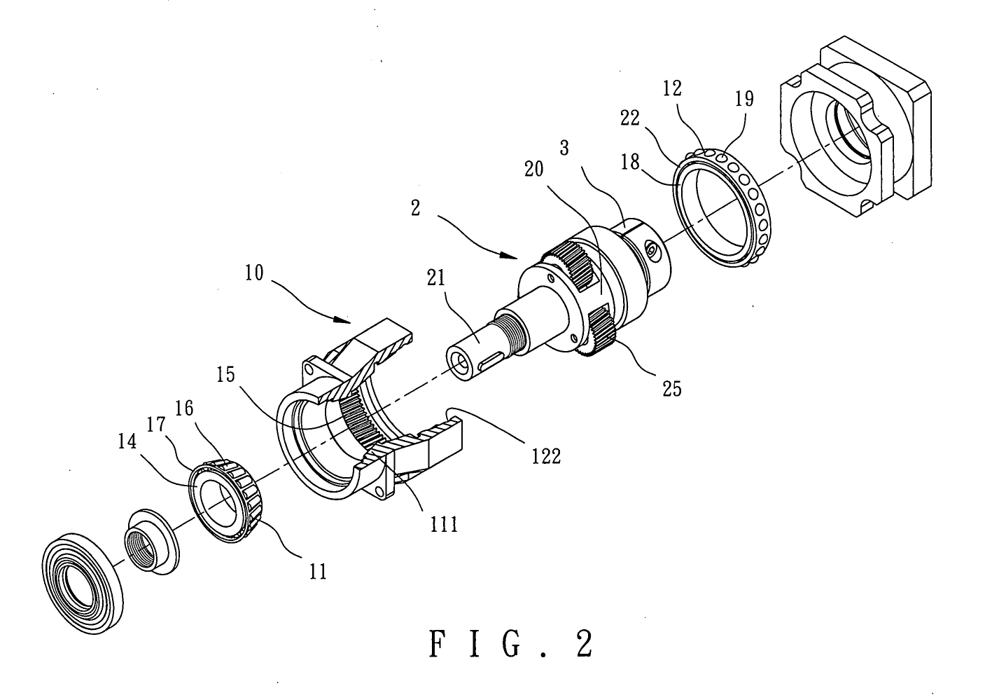

FIG. 3 is a cross-sectional view of the planet-gear speed reducer shown in FIG. 1; and

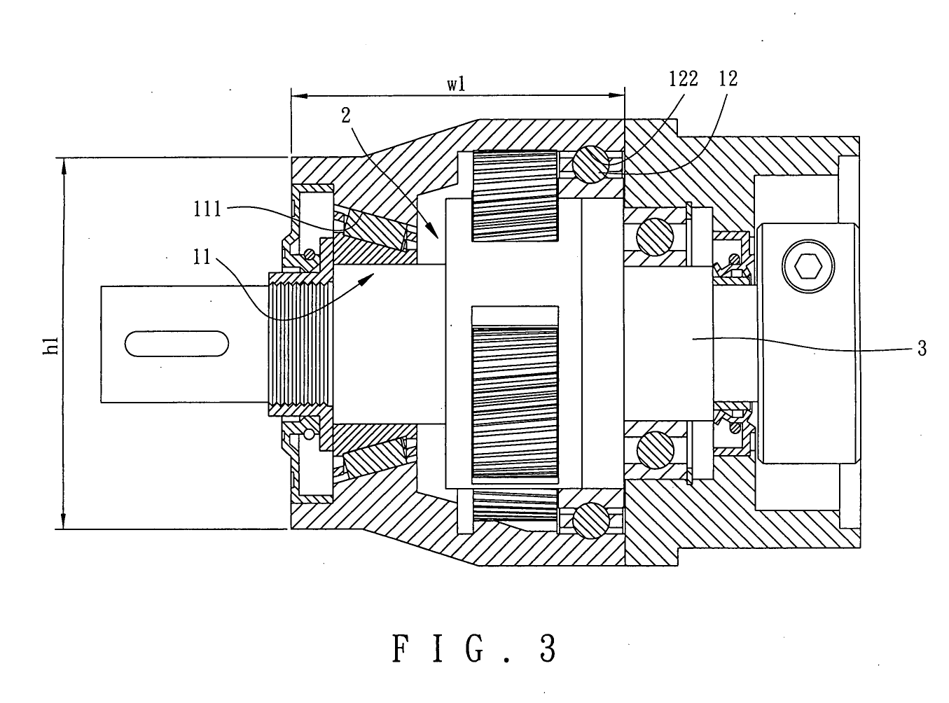

FIG. 4 is a cross-sectional view of a conventional planet-gear speed reducer.

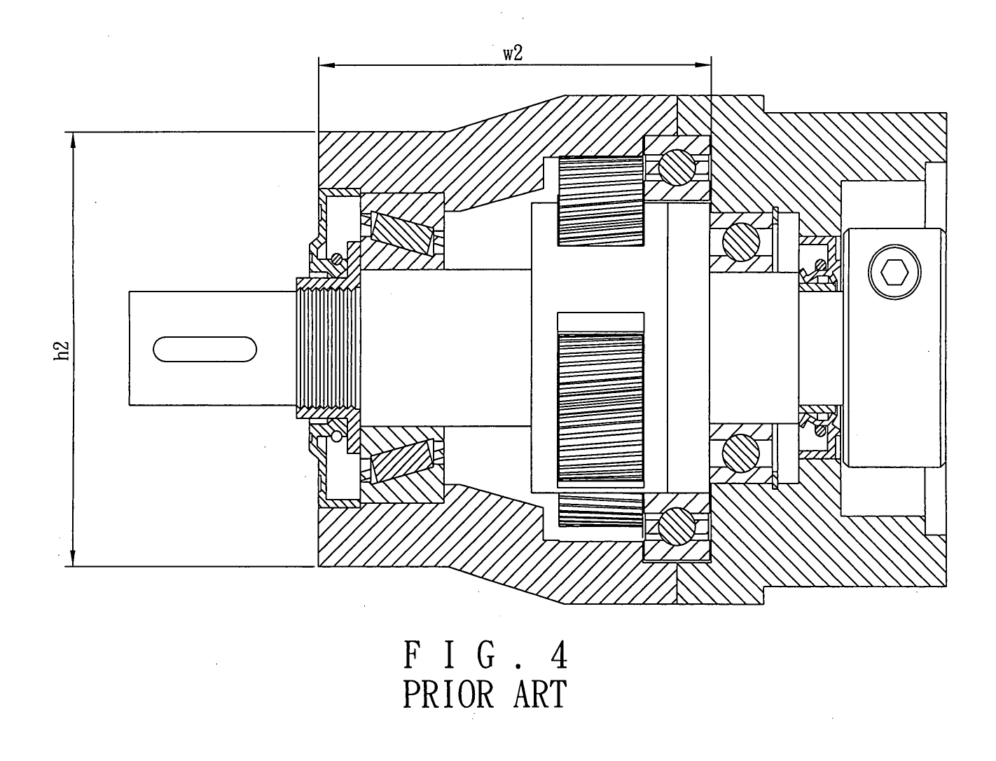

### DETAILED DESCRIPTION OF PREFERRED EMBODIMENT

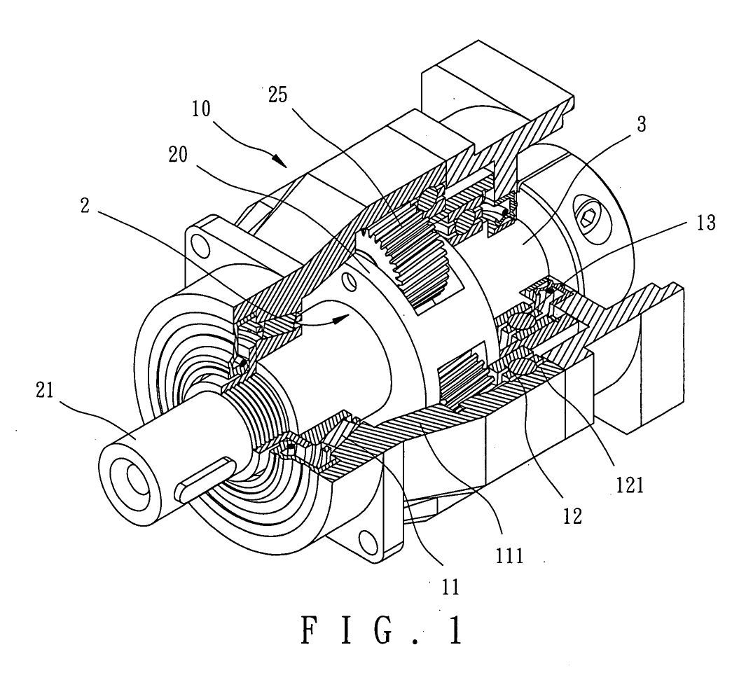

Referring to FIGS. 1, a planet-gear speed reducer includes a shell 10, a planet gear set 2, a sun gear set 3, two semi-bearings 11 and 12, and a bearing 13 according to the preferred embodiment of the present invention. The shell 10 includes first and second sections that are made separately and then joined together. The first section of the shell 10 includes an annular toothed strip 15 formed on an internal side thereof. The internal side of the first section of the shell 10 includes two annular smooth strips 111 and 121. An annular groove 122 is defined in the annular smooth strip 121.

The planet gear set 2 includes a carrier 20 rotationally located in the shell 10 and planet gears 25 rotationally carried on the carrier 20. The carrier 20 includes an output axle 21 extended from an end. The planet gears 25 are engaged with the annular toothed strip 15 of the shell 10. The sun gear set 3 includes a sun gear with teeth engaged with the teeth of the planet gears 25. On the other hand, the sun gear set 3 is connected to the mandrel of a motor. The bearing 13 is located between the sun gear set 3 and the second section of the shell 10.

Each of the semi-bearings 11 and 12 is provided between the shell 10 and the planet gear set 2 to ensure smooth relative rotation between them. The units 11 and 12 are given the term “semi-bearings” because each of them does not include all of the components of a typical bearing. A typical includes an internal ring, an external ring, balls or rollers, and a cage for positioning the balls or rollers between the internal and external rings. The semi-bearing 11 includes an internal ring 14, rollers 16, and a cage 17 for positioning the rollers 16 around the internal ring 14, but does not include an external ring. The rollers 16 are in the form of a pin. The semi-bearing 12 includes an internal ring 18, rollers 19, and a cage 22 for positioning the rollers 19 around the internal ring 18, but does not include an external ring. The rollers 19 are in the form of a ball. The annular smooth strip 111 is used as an external ring of the semi-bearing 11. The annular smooth strip 121 is used as an external ring of the semi-bearing 12. The annular groove 122 receives the balls of the semi-bearing 12.

The planet-gear speed reducer exhibits several advantages over the conventional planet-gear speed reducer discussed in the RELATED PRIOR ART. First, an external diameter h1 of the planet-gear speed reducer of the present invention is smaller than the external diameter h2 of the conventional planet-gear speed reducer. This is partly because external rings of typical bearings are omitted. This is partly because the wall of the shell 10 does not have to be thick to withstand large stress. The stress in the shell 10 caused by the location of the semi-bearings 11 and 12 within the shell 10 is small because the semi-bearings 11 and 12 are not fit in the shell 10 by force.

Secondly, an axial dimension w1 of the planet-gear speed reducer of the present invention is smaller than the external diameter w2 of the conventional planet-gear speed reducer. This is because the shell 10 does not include any annular shoulder on the internal side for abutment against any bearing.

Thirdly, it is easier to locate the planet gear set 2 within the shell 10 according to the present invention than the prior art. One reason for this is that the shell 10 does not include any annular shoulders and does not entail related errors. Another reason for this is that the planet gear set is not fit in the cage by force, thus eliminating related errors.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A planet-gear speed reducer comprising:
a shell (10) includes an annular toothed strip (15), a first annular smooth strip (111) and a second annular smooth strip (112) formed on an internal side;
a planet gear set (2) including a carrier (20) rotationally located within the shell (10) and planet gears (25) carried on the carrier (20);
a sun gear set (3) engaged with the planet gears (25);
a first semi-bearing (11) including an internal ring (14) provided around a section of the carrier (20), rollers (16) and a cage (17) for positioning the rollers (16) between the internal ring (14) thereof and the first annular smooth strip (111) of the shell (10);
a second semi-bearing (12) including an internal ring (18) provided around another section of the carrier (20), rollers (19) and a cage (22) for positioning the rollers (19) between the internal ring (18) thereof and the second annular smooth strip (121) of the shell (10); and
a bearing (13) located between the sun gear set (3) and the shell (10).

2. The planet-gear speed reducer according to claim 1, wherein the shell (10) includes an annular groove (122) defined in the second annular smooth strip (121), wherein the rollers (19) of the second semi-bearing (12) are balls located within the annular groove (122).

3. The planet-gear speed reducer according to claim 1, wherein the rollers (16) of the first semi-bearing (11) are pins.
